(19) United States
(12) Patent Application Publication
(10) Pub. No.: US 2023/0044401 A1
(43) Pub. Date: Feb. 9, 2023

(54) INFORMATION PROCESSING DEVICE, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Kotaro OKABE, Ichikawa-shi (JP); Mayuko ABE, Shinagawa-ku (JP); Satoshi KOMAMINE, Nagoya-shi (JP); Takeaki DOHDA, Nagoya-shi (JP); Ken MATSUSHITA, Nagoya-shi (JP); Yosuke TAKADA, Nagoya-shi (JP)

(21) Appl. No.: 17/817,073

(22) Filed: Aug. 3, 2022

(30) Foreign Application Priority Data
Aug. 6, 2021 (JP) 2021-130266

(51) Int. Cl. G06Q 10/08; G06Q 10/06; G05D 1/10; B64C 39/02

(52) U.S. Cl. CPC G06Q 10/0832; G06Q 10/06316; G05D 1/101; B64C 39/024; B64C 2201/128; B64C 2201/141; B64C 2201/208

(57) ABSTRACT

An information processing device determines, based on location information of a plurality of delivery destinations for package delivery: one or a plurality of first delivery destinations for package delivery by a vehicle; and one or a plurality of second delivery destinations for package delivery by a drone mounted on the vehicle. In addition, the information processing device determines: a travel route including a route for the vehicle to perform package delivery to the one or plurality of first delivery destinations; a first point on the travel route for the drone to start flying from the vehicle to the one or plurality of second delivery destinations; and a second point on the travel route for the drone to return to the vehicle.

### CROSS REFERENCE TO THE RELATED APPLICATION

This application claims the benefit of Japanese Patent Application No. 2021-130266, filed on Aug. 6, 2021, which is hereby incorporated by reference herein in its entirety.

### BACKGROUND

### Technical Field

The present disclosure relates to an information processing device, an information processing method, and a non-transitory storage medium.

### Description of the Related Art

Japanese Patent Laid-Open No. 2020-128287 discloses a vehicle that performs package delivery to a plurality of delivery places. The vehicle in the disclosure stores a mobile body that performs package delivery from destinations to delivery places. The vehicle sets one or a plurality of destinations based on the degree of spreading of a plurality of delivery places. Then, the vehicle travels from a current position toward the set one or plurality of destinations.

### SUMMARY

It is an object of the present disclosure to provide a technique for efficient package delivery.

An information processing device according to a first aspect of the present disclosure includes a controller comprising at least one processor. The controller is configured to determine, based on location information of a plurality of delivery destinations for package delivery: one or a plurality of first delivery destinations for package delivery by a vehicle; one or a plurality of second delivery destinations for package delivery by a drone mounted on the vehicle; a travel route including a route for the vehicle to perform package delivery to the one or plurality of first delivery destinations; a first point on the travel route for the drone to start flying from the vehicle to the one or plurality of second delivery destinations; and a second point on the travel route for the drone to return to the vehicle.

An information processing method according to a second aspect of the present disclosure is executed by a computer. The information processing method includes determining, based on location information of a plurality of delivery destinations for package delivery: one or a plurality of first delivery destinations for package delivery by a vehicle; one or a plurality of second delivery destinations for package delivery by a drone mounted on the vehicle; a travel route including a route for the vehicle to perform package delivery to the one or plurality of first delivery destinations; a first point on the travel route for the drone to start flying from the vehicle to the one or plurality of second delivery destinations; and a second point on the travel route for the drone to return to the vehicle.

A non-transitory storage medium according to a third aspect of the present disclosure stores a program that causes a computer to execute an information processing method. The information processing method includes determining, based on location information of a plurality of delivery destinations for package delivery: one or a plurality of first delivery destinations for package delivery by a vehicle; one or a plurality of second delivery destinations for package delivery by a drone mounted on the vehicle; a travel route including a route for the vehicle to perform package delivery to the one or plurality of first delivery destinations; a first point on the travel route for the drone to start flying from the vehicle to the one or plurality of second delivery destinations; and a second point on the travel route for the drone to return to the vehicle.

The present disclosure allows efficient package delivery.

### BRIEF DESCRIPTION OF THE DRAWINGS

FIG. 1 is a diagram illustrating a schematic configuration of a management system;

FIG. 2 is a diagram illustrating an overview of package delivery by a vehicle and a drone;

FIG. 3 is a block diagram schematically illustrating an example of a functional configuration of a management server;

FIG. 4 is a diagram illustrating an example of a table configuration of delivery destination information;

FIG. 5 is a diagram illustrating an example of the travel route, flight start point, and return point that are determined by the management server in a first embodiment;

FIG. 6 is a flowchart of determination processing; and

FIG. 7 is a diagram illustrating an example of the travel route, flight start point, and return point that are determined by the management server in a second embodiment.

### DESCRIPTION OF THE EMBODIMENTS

An information processing device according to a first aspect of the present disclosure is an information processing device that manages package delivery. Here, the package delivery is performed by a vehicle and a drone mounted on the vehicle. The drone mounted on the vehicle is loaded with a package and takes off from the vehicle to deliver the package. A controller comprising at least one processor in the information processing device according to the first aspect of the present disclosure determines one or a plurality of first delivery destinations and one or a plurality of second delivery destinations, based on location information of a plurality of delivery destinations. Here, the first delivery destination is a delivery destination, among the plurality of delivery destinations, to which package delivery is to be performed by the vehicle. In addition, the second delivery destination is a delivery destination to which package delivery is to be performed by the drone mounted on the vehicle.

In addition, the controller in the information processing device determines a travel route, a first point, and a second point. Here, the travel route includes a route for the vehicle to perform package delivery to the one or plurality of first delivery destinations. The first point is a point on the travel route for the drone to start flying from the vehicle to the one or plurality of second delivery destinations. The second point is a point on the travel route for the drone to return to the vehicle. Thus, the controller determines the first point and thereby, the drone starts flying from the vehicle to the one or plurality of second delivery destinations. In addition, the vehicle travels along the travel route. Then, the drone can return to the vehicle at the return point.

As described above, the information processing device determines one or a plurality of first delivery destinations and one or a plurality of second delivery destinations, based on location information. In addition, the information processing device determines a travel route, a first point, and a second point. This allows package delivery by a vehicle to delivery destinations that are located suitably for delivery by the vehicle. This also allows package delivery by a drone to delivery destinations that are located suitably for delivery by the drone. Thus, the information processing device allows efficient package delivery.

Hereinafter, specific embodiments of the present disclosure will be described with reference to drawings. The dimensions, materials, shapes, relative arrangements and the like of the components described in these embodiments are not intended to limit a technical scope of the present disclosure thereto unless otherwise stated.

### First Embodiment

(System Overview)

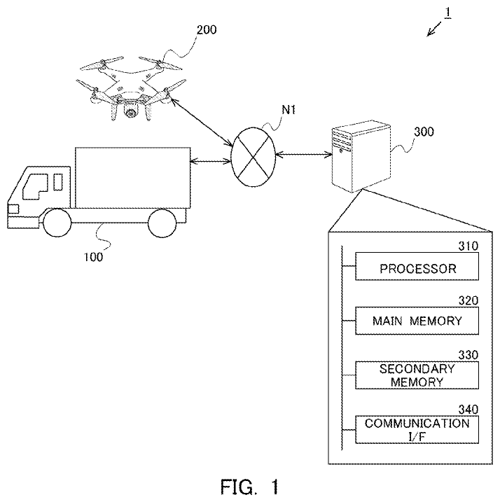

A management system 1 in this embodiment will be described with reference to FIG. 1. FIG. 1 is a diagram illustrating a schematic configuration of the management system 1. The management system 1 includes a vehicle 100, a drone 200, and a management server 300. In the management system 1, the vehicle 100, the drone 200, and the management server 300 are mutually connected by a network N1. As the network N1, for example, a wide area network (WAN) which is a global public communication network such as the Internet, or a telephone communication network such as for a cellular phone may be employed.

(Vehicle)

The vehicle 100 is a vehicle used for package delivery. The vehicle 100 travels to the vicinity of a delivery destination. Then, a passenger of the vehicle 100 carries a package to the delivery destination, to have the package delivered to the delivery destination. It should be noted that package delivery may be performed either using the method in which the vehicle 100 travels to the vicinity of a delivery destination and a passenger of the vehicle 100 carries the package to the delivery destination or by another method. For example, the vehicle 100 may autonomously travel directly to a delivery destination and deliver a package loaded on the vehicle 100 to the delivery destination. In this case, when a delivery destination of the package is inside a building, the vehicle 100 autonomously travels inside the building and performs package delivery to the delivery destination.

(Drone)

The drone 200 is used for package delivery. In addition, the drone 200 is mounted on the vehicle 100. The drone 200 is loaded with a package, and flies from the vehicle 100 to a delivery destination of the package. In this manner, the drone 200 performs package delivery to the delivery destination.

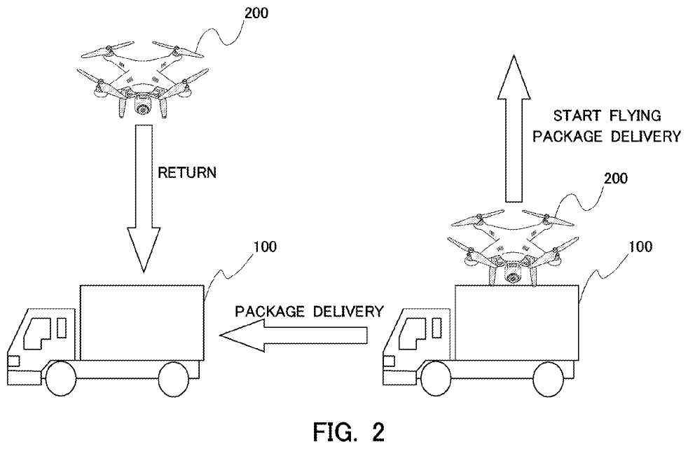

FIG. 2 is a diagram illustrating an overview of package delivery by the vehicle 100 and the drone 200. As illustrated in FIG. 2, the drone 200 is mounted on the vehicle 100. The drone 200 starts flying from the vehicle 100 to a package delivery destination to perform package delivery. When the drone 200 finishes the package delivery, it returns to the vehicle 100. Meanwhile, as illustrated in FIG. 2, the vehicle 100 has moved for package delivery. Therefore, a point where the drone 200 takes off from the vehicle 100 and a point where the drone 200 returns to the vehicle 100 may be different points. Details of package delivery by the vehicle 100 and the drone 200 will be described later.

(Management Server)

The management server 300 manages package delivery by the vehicle 100 and the drone 200. The management server 300 includes a computer having a processor 310, a main memory 320, a secondary memory 330, and a communication interface (communication I/F) 340. The processor 310 is, for example, a central processing unit (CPU) or a digital signal processor (DSP). The main memory 320 is, for example, a random access memory (RAM). The secondary memory 330 is, for example, a read only memory (ROM). Alternatively, the secondary memory 330 is, for example, a hard disk drive (HDD) or a disk recording medium such as a CD-ROM, a DVD disk, or a Blu-ray disk. The secondary memory 330 may be removable media (removable storage medium). Here, examples of the removal media include a USB memory and an SD card. Examples of the communication I/F 340 include a local area network (LAN) interface board or a wireless communication circuit for wireless communication.

On the management server 300, the secondary memory 330 stores an operating system (OS), various programs, and various information tables. In addition, on the management server 300, the processor 310 loads the programs stored in the secondary memory 330 onto the main memory 320 and executes them, thereby allowing various functions described later to be implemented. However, part or all of the functions in the management server 300 may be implemented by a hardware circuit such as ASIC or FPGA. Furthermore, the management server 300 is not necessarily required to be implemented by a single physical configuration and may be configured by a plurality of computers that cooperate with each other. The vehicle 100 and the drone 200 also include a computer, as with the management server 300.

(Functional Configuration)

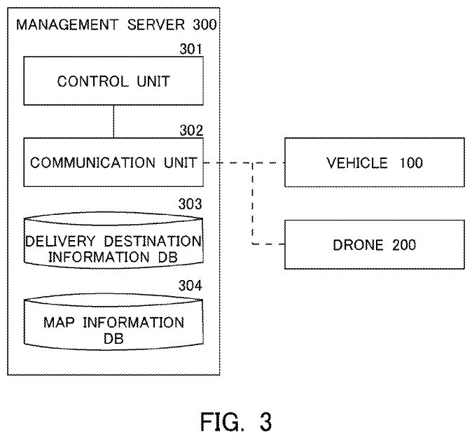

Next, description will be made with reference to FIG. 3 to FIG. 5, as to the functional configuration of the management server 300 included in the management system 1. FIG. 3 is a block diagram schematically illustrating an example of the functional configuration of the management server 300. The management server 300 includes a control unit 301, a communication unit 302, a delivery destination information database (delivery destination information DB) 303, and a map information database (map information DB) 304. The communication unit 302 has a function for connecting the management server 300 to the network N1. The communication unit 302 can be implemented by the communication I/F 340 in the management server 300.

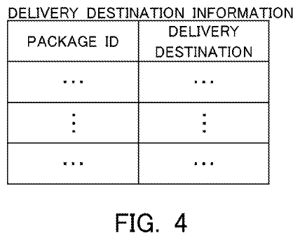

The delivery destination information DB 303 has a function of storing delivery destination information. The delivery destination information is location information of destinations for package delivery by the vehicle 100 and the drone 200. The delivery destination information is input, for example, by a manager of the management server 300. The delivery destination information DB 303 can be implemented by the secondary memory 330 in the management server 300. FIG. 4 is a diagram illustrating an example of a table configuration of the delivery destination information. As illustrated in FIG. 4, the delivery destination information includes a package ID field and a delivery destination field.

In the package ID field, an identifier for identifying a package (package ID) is input. In this embodiment, the delivery destination information has a plurality of records for inputting package IDs of a plurality of packages. That is, the vehicle 100 and the drone 200 deliver a plurality of packages to a plurality of delivery destinations. In the delivery destination field, information for specifying the location of a delivery destination of a package corresponding to a package ID that is input in the package ID field is input. In the delivery destination field, an address of a delivery destination, for example, is input.

The map information DB 304 has a function of storing map information. The map information is information including a map of roads and buildings in an area where the vehicle 100 and the drone 200 perform package delivery. The map information DB 304 can be implemented by the secondary memory 330 in the management server 300.

The control unit 301 has a function of performing arithmetic processing for controlling the management server 300. The control unit 301 can be implemented by the processor 310 in the management server 300. The control unit 301 obtains delivery destination information that is stored in the delivery destination information DB 303. The control unit 301 determines a delivery destination to which the vehicle 100 performs package delivery (hereinafter, may be referred to as “first delivery destination”), based on the obtained delivery destination information. In addition, the control unit 301 determines a delivery destination to which the drone 200 performs package delivery (hereinafter, may be referred to as “second delivery destination”), based on the obtained delivery destination information.

More specifically, the control unit 301 determines an area dense with delivery destinations (hereinafter, may be referred to as “dense area”), based on the delivery destination information. The control unit 301 calculates the number of delivery destinations per unit area, based on location information of a plurality of delivery destinations that are input in the delivery destination field in the delivery destination information. The control unit 301 determines a dense area based on the calculated number of delivery destinations per unit area. Then, the control unit 301 determines delivery destinations in the dense area, as the first delivery destinations. In addition, the control unit 301 determines delivery destinations outside the dense area, as the second delivery destinations. In this embodiment, the control unit 301 determines a plurality of first delivery destinations and one second delivery destination.

Furthermore, the control unit 301 determines a travel route, a flight start point, and a return point, based on the locations of the first delivery destinations and the location of the second delivery destination. Here, the travel route includes a route for the vehicle 100 to perform package delivery to the plurality of first delivery destinations. The flight start point is a point on the travel route for the drone 200 to start flying from the vehicle 100 to the second delivery destination. The return point is a point on the travel route for the drone 200 to return to the vehicle 100.

In this embodiment, the control unit 301 first calculates, as a travel route, a route that is the most efficient for performing package delivery to the plurality of first delivery destinations. Then, the control unit 301 determines a flight start point and a return point on the calculated travel route. Here, the control unit 301 determines the flight start point and the return point, based on the travelable distance of the drone 200. That is, the control unit 301 calculates a distance required for the drone to start flying from the flight start point, perform package delivery to the second delivery destination, and arrive at the return point (flight distance). Then, the control unit 301 determines the flight start point and the return point so that the flight distance of the drone 200 is equal to or less than the travelable distance of the drone 200.

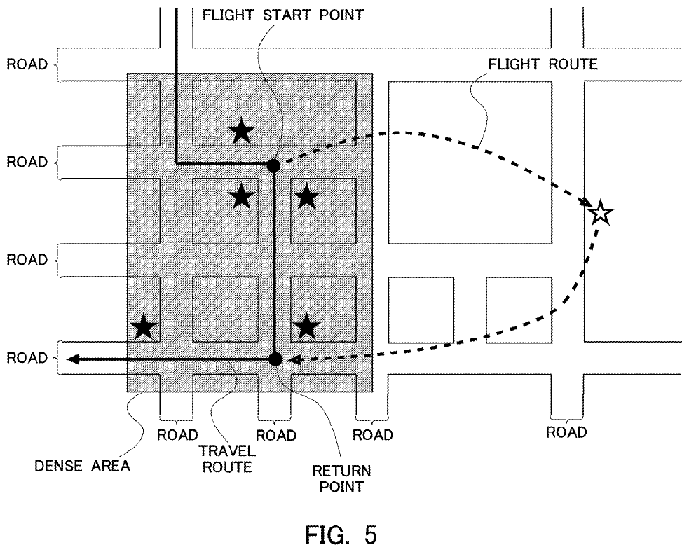

FIG. 5 is a diagram illustrating an example of the travel route, flight start point, and return point that are determined by the management server 300 in this embodiment. FIG. 5 illustrates a map of an area in which the vehicle 100 and the drone 200 performs package delivery. As illustrated in FIG. 5, a dense area is determined by the management server 300. Here, the dense area illustrated in FIG. 5 is an area where the number of delivery destinations per unit area is more than a predetermined threshold. In FIG. 5, the first delivery destinations are represented by filled star symbols. The vehicle 100 performs package delivery to the plurality of first delivery destinations in the dense area along the travel route illustrated in FIG. 5.

In addition, in the example illustrated in FIG. 5, the drone 200 performs package delivery to the second delivery destination located outside the dense area. In FIG. 5, the second delivery destination is represented by an open star symbol. The drone 200 starts flying at the flight start point illustrated in FIG. 5 and performs package delivery to the second delivery destination. Then, the drone 200 returns to the vehicle 100 at the return point. As described above, the drone 200 flies along a flight route from the flight start point through the second delivery destination to the return point, as illustrated in FIG. 5.

The control unit 301 generates, when a travel route, a flight start point, and a return point are determined, travel information on the travel route and flight information on a flight route. Here, the flight information includes information on the flight start point and the return point. In addition, the flight information includes location information of the second delivery destination. Then, the control unit 301 transmits the travel information to the vehicle 100 via the communication unit 302. In addition, the control unit 301 transmits the flight information to the drone 200 via the communication unit 302.

(Determination Processing)

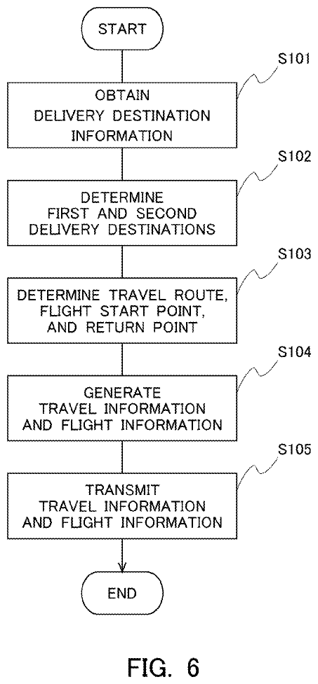

Next, determination processing executed by the control unit 301 of the management server 300 in the management system 1 will be described with reference to FIG. 6. In the determination processing, a travel route, a flight start point, and a return point are determined. FIG. 6 is a flowchart of the determination processing.

In the determination processing, first at S101, delivery destination information is obtained from the delivery destination information DB 303. Next, at S102, a plurality of first delivery destinations and a second delivery destination are determined, based on the locations of delivery destinations in the obtained delivery destination information. More specifically, at S102, a dense area is determined and delivery destinations in the dense area are determined as the first delivery destinations and a delivery destination outside the dense area is determined as the second delivery destination. Then, at S103, a travel route for the vehicle 100, and a flight start point and a return point for the drone 200 are determined. Next, at S104, travel information is generated based on the determined travel route. In addition, at S104, flight information is generated based on the flight start point and the return point. Next, at S105, the travel information is transmitted to the vehicle 100 and the flight information is transmitted to the drone 200. Then, the vehicle 100 travels along the travel route based on the received travel information. In addition, the drone 200 flies along the flight route based on the received flight information. Then, the determination processing ends.

As described above, the management server 300 in the management system 1 determines a plurality of first delivery destinations and a second delivery destination. Then, the management server 300 determines a travel route, a flight start point, and a return point. This allows package delivery to be performed by the vehicle 100 to the first delivery destinations located suitably for delivery by the vehicle. This also allows package delivery to be performed by the drone 200 to the second delivery destination located away from a dense area. As a result, package delivery to the second delivery destination can be performed without making the vehicle 100 move to the second delivery destination located away from the dense area. Thus, the management system 1 allows efficient package delivery.

(First Modification)

In this embodiment, the drone 200 performs package delivery to one second delivery destination. However, the drone 200 may perform package delivery to a plurality of second delivery destinations. In addition, the vehicle 100 performs package delivery to a plurality of first delivery destinations. However, the vehicle 100 may perform package delivery to one first delivery destination.

(Second Modification)

In this embodiment, the management server 300 determines the first delivery destinations and the second delivery destination based on a dense area. However, the management server 300 is not necessarily required to determine the first delivery destinations and the second delivery destination based on a dense area. The management server 300 may determine, as the first delivery destinations, delivery destinations in a predetermined area along a predetermined road and determine, as the second delivery destination, a delivery destination outside the predetermined area along the predetermined road. Here, the predetermined road is, for example, a road having a width equal to or more than a predetermined width allowing the vehicle 100 to easily perform package delivery. This allows the drone 200 to perform package delivery to a delivery destination along a road that is inconvenient for the vehicle 100 to perform package delivery (the road width is equal to or less than the predetermined width). Also in this manner, efficient package delivery can be performed.

(Third Modification)

The management server 300 may determine a return point based on a time when the drone 200 is scheduled to complete package delivery to the second delivery destination (hereinafter, may be referred to as “scheduled time”). More specifically, the management server 300 computes a time required for the drone 200 to perform package delivery from the flight start point to the second delivery destination and calculates a scheduled time. Then, the management server 300 calculates a return point based on a predicted location of the vehicle 100 at the scheduled time and the location of the second delivery destination. For example, the management server 300 calculates the return point so that a difference between a predicted time when the vehicle 100 will arrive at the return point and a predicted time when the drone 200 will arrive at the return point is within a predetermined range, based on the travel speed of the vehicle 100 and the flight speed of the drone 200. This allows a reduction in time required for the vehicle 100 having arrived at the return point earlier to wait for the drone 200 to arrive at the return point. Otherwise, this allows a reduction in time required for the drone 200 having arrived at the return point earlier to wait for the vehicle 100 to arrive at the return point. As a result, power or fuel consumption by the drone 200 can be reduced.

(Fourth Modification)

In this embodiment, the drone 200 returns during package delivery by the vehicle 100. However, the drone 200 is not necessarily required to return during package delivery by the vehicle 100. The management server 300 may determine a return point on the travel route of the vehicle 100 which is followed before or after the vehicle 100 performs package delivery. In addition, in this embodiment, the flight start point and the return point are determined on a road. However, the flight start point and the return point are not necessarily required to be determined on a road. For example, the flight start point and the return point may be determined at a predetermined place such as an open space where the vehicle 100 can travel. In this case, the travel route of the vehicle 100 is set so as to travel the predetermined place.

### Second Embodiment

In this embodiment, in a package delivery area of the vehicle 100 and the drone 200, an area that allows the drone 200 to start flying from the vehicle 100 and to return to the vehicle 100 (hereinafter, may be referred to as “possible departure/return area) is set. In this embodiment, the management server 300 determines a travel route, a flight start point, and a return point, further based on the possible departure/return area. The following will describe only the differences from the first embodiment.

The possible departure/return area is, for example, an area where it is presumed that the vehicle 100 moves at a speed equal to or lower than a predetermined speed that allows the drone 200 to safely depart from and return to the vehicle 100. In this case, for example, the drone 200 cannot safely depart from and return to the vehicle 100 on a road where it is presumed that the vehicle 100 travels at a speed exceeding the predetermined speed (e.g., expressway). Therefore, the expressway may not be a possible departure/return area.

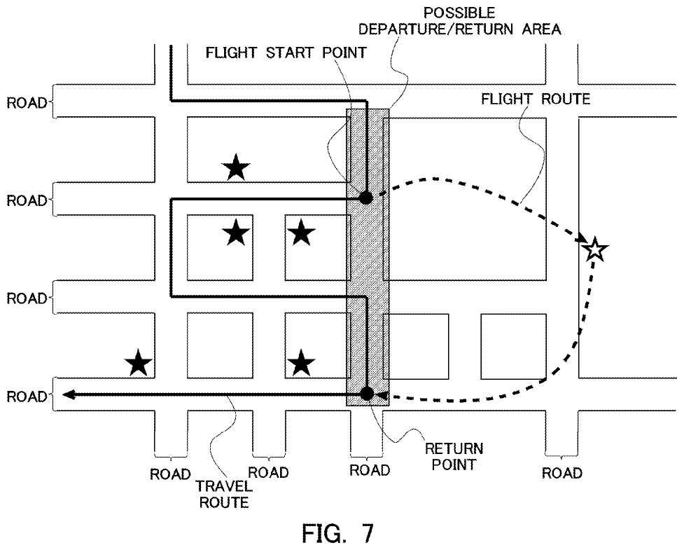

The control unit 301 obtains a possible departure/return area from map information stored in the map information DB 304. Then, the control unit 301 determines a travel route, a flight start point, and a return point, based on the locations of a plurality of first delivery destinations, the location of a second delivery destination, and the possible departure/return area. FIG. 7 is a diagram illustrating an example of the travel route, flight start point, and return point that are determined by the management server 300 in this embodiment.

Here, the locations of the plurality of first delivery destinations and the location of the second delivery destination in FIG. 7 are the same as the location of the plurality of first delivery destinations and the location of the second delivery destination illustrated in FIG. 5. The delivery destinations in a dense area are determined as the plurality of first delivery destinations as with the first embodiment.

In addition, the possible departure/return area is set in the range illustrated in FIG. 7 and the travel route illustrated in FIG. 5 is not included in the possible departure/return area. Therefore, when the vehicle 100 travels along the travel route illustrated in FIG. 5, the drone 200 cannot depart from and return to the vehicle 100. To avoid this, the control unit 301 determines a travel route so as to have the travel route included in the possible departure/return area. In addition, the control unit 301 determines, as a flight start point and a return point, points on the travel route that are included in the possible departure/return area. Thus, the management system 1 allows efficient package delivery even when a possible flight area is set.

(Modification)

In this embodiment, the possible departure/return area is an area where it is presumed that the vehicle 100 moves at a speed that allows the drone 200 to safely depart from and return to the vehicle 100. However, the possible departure/return area may be an area other than the area where it is presumed that the vehicle 100 moves at a speed that allows the drone 200 to safely depart from and return to the vehicle 100. The possible departure/return area may be an area having therearound predetermined space enough for the drone 200 to start flying from the vehicle 100. This can prevent any danger from occurring when the drone 200 departs from or returns to the vehicle 100 due to insufficient space for the drone 200 to depart and return in.

In addition, the possible departure/return area may be, for example, an area where the vehicle 100 can temporarily stop. In this case, the management server 300 determines two points where the vehicle 100 can temporarily stop as a flight start point and a return point. Thus, the vehicle 100 temporarily stops in the possible departure/return area and thereby, the drone 200 can safely depart from or return to the vehicle 100.

### Third Embodiment

In the first embodiment, the management server 300 determines a first delivery destination and a second delivery destination based on a dense area. On the other hand, in this embodiment, the management server 300 determines the first delivery destination and the second delivery destination based on the altitude of each delivery destination. The following will describe only the differences from the first embodiment.

(Management Server)

The delivery destination information that is stored in the delivery destination information DB 303 in the management server 30 includes information on the altitudes of delivery destinations. More specifically, a delivery destination field in the delivery destination information that is stored in the delivery destination information DB 303 includes the address of a delivery destination and also, information on the altitude of the delivery destination. Information on the altitude of a delivery destination is, for example, information on the floor level of a building of a delivery destination. Alternatively, information on the altitude of a delivery destination may be information on the elevation, altitude above sea level, or height with respect to a road of the delivery destination.

The control unit 301 in the management server 300 determines a plurality of first delivery destinations and a plurality of second delivery destinations from among a plurality of package delivery destinations, further based on information on the altitude of each delivery destination. More specifically, the control unit 301 determines delivery destinations whose floor levels are equal to or higher than a predetermined level as the second delivery destinations, based on information on the altitude of each delivery destination. In addition, the control unit 301 determines delivery destinations whose floor levels are lower than a predetermined floor level as the first delivery destinations.

As described above, the management server 300 in the management system 1 determines delivery destinations whose floor levels are equal to or higher than a predetermined floor level as the second delivery destinations. This eliminates a passenger of the vehicle 100 having to move up to a floor level of a delivery destination to perform package delivery to the delivery destination that is on the upper floor level of a building. As a result, the time required to perform package delivery to a plurality of delivery destinations can be reduced. Also in this manner, efficient package delivery can be performed.

### Other Embodiments

The above embodiments are merely examples, and the present disclosure can be appropriately modified and implemented without departing from the spirit thereof. In addition, the processing and means described in the present disclosure can be implemented in any combination as long as there is no technical contradiction.

In addition, the processing described as being performed by one device may be executed in a shared manner by a plurality of devices. Alternatively, the processing described as being performed by different devices may be executed by one device. In a computer system, what hardware configuration (server configuration) realizes each function can be flexibly changed.

The present disclosure can also be realized by supplying a computer program including the functions described in the above embodiments to a computer and causing one or more processors included in the computer to read and execute the program. Such a computer program may be provided to the computer by a non-transitory computer-readable storage medium connectable to a system bus of the computer, or may be provided to the computer via a network. Examples of non-transitory computer-readable storage media include any type of disk such as a magnetic disk (floppy (registered trademark) disk, hard disk drive (HDD), etc.) and an optical disk (CD-ROM, DVD disk, Blu-ray disk, etc.), a read-only memory (ROM), a random access memory (RAM), an EPROM, an EEPROM, a magnetic card, a flash memory, an optical card, or any type of medium suitable for storing electronic instructions.

What is claimed is:

1. An information processing device, comprising:
a controller comprising at least one processor configured to determine, based on location information of a plurality of delivery destinations for package delivery:
one or a plurality of first delivery destinations for package delivery by a vehicle;
one or a plurality of second delivery destinations for package delivery by a drone mounted on the vehicle;
a travel route including a route for the vehicle to perform package delivery to the one or plurality of first delivery destinations;
a first point on the travel route, the first point being for the drone to start flying from the vehicle to the one or plurality of second delivery destinations; and
a second point on the travel route, the second point being for the drone to return to the vehicle.

2. The information processing device according to claim 1, wherein
the controller is configured to determine, from among the plurality of delivery destinations: at least one delivery destination in a predetermined first area, as the one or plurality of first delivery destinations;
and one or a plurality of delivery destinations outside the predetermined first area, as the one or plurality of second delivery destinations.

3. The information processing device according to claim 2, wherein
the controller is configured to:
calculate a number of delivery destinations per unit area, based on the location information; and
determine the predetermined first area based on the number of delivery destinations per unit area.

4. The information processing device according to claim 2, wherein
the predetermined first area is an area along a predetermined road.

5. The information processing device according to claim 1, wherein
the location information includes information on altitudes of the plurality of delivery destinations, and
the controller is configured to determine the one or plurality of first delivery destinations and the one or plurality of second delivery destinations, based on the altitudes of the plurality of delivery destinations.

6. The information processing device according to claim 1, wherein
the controller is configured to determine the first point and the second point, based on a travelable distance of the drone.

7. The information processing device according to claim 1, wherein
the controller is configured to determine the travel route, the first point, and the second point, further based on a predetermined second area that allows the drone to start flying from the vehicle and to return to the vehicle.

8. The information processing device according to claim 1, wherein
the controller is configured to determine the second point, based on a scheduled time when the drone is to complete delivery to the one or plurality of second delivery destinations.

9. An information processing method executed by a computer, comprising:
determining, based on location information of a plurality of delivery destinations for package delivery:
one or a plurality of first delivery destinations for package delivery by a vehicle;
one or a plurality of second delivery destinations for package delivery by a drone mounted on the vehicle;
a travel route including a route for the vehicle to perform package delivery to the one or plurality of first delivery destinations;
a first point on the travel route, the first point being for the drone to start flying from the vehicle to the one or plurality of second delivery destinations; and
a second point on the travel route, the second point being for the drone to return to the vehicle.

10. The information processing method according to claim 9, comprising:
determining, from among the plurality of delivery destinations:
at least one delivery destination in a predetermined first area, as the one or plurality of first delivery destinations; and
one or a plurality of delivery destinations outside the predetermined first area, as the one or plurality of second delivery destinations.

11. The information processing method according to claim 10, comprising:
calculating a number of delivery destinations per unit area, based on the location information; and
determining the predetermined first area, based on the number of delivery destinations per unit area.

12. The information processing method according to claim 10, wherein
the predetermined first area is an area along a predetermined road.

13. The information processing method according to claim 9, wherein
the location information includes information on altitudes of the plurality of delivery destinations; and
the information processing method comprises:
determining, based on the altitudes of the plurality of delivery destinations:
the one or plurality of first delivery destinations and;
the one or plurality of second delivery destinations.

14. The information processing method according to claim 9, comprising:
determining the first point and the second point, based on a travelable distance of the drone.

15. The information processing method according to claim 9, comprising:
determining the travel route, the first point, and the second point, further based on a predetermined second area that allows the drone to start flying from the vehicle and to return to the vehicle.

16. The information processing method according to claim 9, comprising:
determining the second point, based on a scheduled time when the drone is to complete delivery to the one or plurality of second delivery destinations.

17. A non-transitory storage medium storing a program that causes a computer to execute an information processing method, wherein
the information processing method comprises:
determining, based on location information of a plurality of delivery destinations for package delivery:
one or a plurality of first delivery destinations for package delivery by a vehicle;
one or a plurality of second delivery destinations for package delivery by a drone mounted on the vehicle;
a travel route including a route for the vehicle to perform package delivery to the one or plurality of first delivery destinations;
a first point on the travel route, the first point being for the drone to start flying from the vehicle to the one or plurality of second delivery destinations; and
a second point on the travel route, the second point being for the drone to return to the vehicle.

18. The non-transitory storage medium according to claim 17, wherein
the information processing method comprises:
determining, from among the plurality of delivery destinations:
at least one delivery destination in a predetermined first area, as the one or plurality of first delivery destinations; and
one or a plurality of delivery destinations outside the predetermined first area, as the one or plurality of second delivery destinations.

19. The non-transitory storage medium according to claim 18, wherein
the information processing method comprises:
calculating a number of delivery destinations per unit area, based on the location information; and
determining the predetermined first area, based on the number of delivery destinations per unit area.

20. The non-transitory storage medium according to claim 17, wherein
the location information includes information on altitudes of the plurality of delivery destinations; and
the information processing method comprises:
determining, based on the altitudes of the plurality of delivery destinations:
the one or plurality of first delivery destinations and;
the one or plurality of second delivery destinations.
